(19) United States
(12) Patent Application Publication
(10) Pub. No.: US 2009/0086480 A1
(43) Pub. Date: Apr. 2, 2009

(54) LAMP

(76) Inventor: CHE-YEN CHEN, Sanchong City (TW)

Correspondence Address: KILE GOEKJIAN REED & MCMANUS, PLLC, SUITE 570, 1200 NEW HAMPSHIRE AVENUE, NW, WASHINGTON, DC, 20036, US

(21) Appl. No.: 12/202,338

(22) Filed: Sep. 1, 2008

(30) Foreign Application Priority Data
Sep. 28, 2007 (TW) 96136132

(51) Int. Cl. F21V 1/00

(52) U.S. Cl. 362/235

(57) ABSTRACT

The present invention disclosed a lamp, which includes a lampshade, a seat, a light-guiding element, a reflecting layer, and a plurality of circuit boards. The seat shows a cylindrical shape. The seat is installed in the lampshade. The light-guiding element corresponding to the seat is for light mixing. The light-guiding element is installed between the lampshade and the seat. The reflecting layer is disposed between the lampshade and the light-guiding element. Each of the circuit boards has a LED thereon. The circuit boards are installed on the seat. As a result, the light area becomes broad via the reflecting layer and then the light is overlapped in the light-guiding element to achieve the light-mixing effect. Thereby, the light transform from point to plane.

### BACKGROUND OF THE INVENTION

1. Field of the Invention

The present invention relates to a lamp and more particular to an improved lamp applying LEDs for increasing brightness.

2. Description of Related Art

Traditional Tungsten lamps produces light source that scatters, therefore ensures a certain degree of brightness to the surrounding area, however traditional tungsten lamps has the disadvantage of low electricity conversion into light, thus, there is now a growing trend of replacing the traditional tungsten lamps with light emitting diodes (LEDs).

However, light emitted by LEDs is straight and not scattered, i.e. the light can only be focused on particular points. Thus, the brightness in locations outside of the lamp's light beam may be insufficient.

According to the above, an improvement proposed. For example, the Taiwan patent number M317545 (publication date: 2007.08.21) discloses a lamp having LED, which includes a circuit board, LED, and reflecting body. The LED is wielded on the circuit board. The reflecting body corresponding to the LED forms a concave. The inside plane of the concave is reflecting plane. The bottom of the concave forms a hole for penetrating the LED. As a result, via the reflecting plane, the light of the LED can be scattering. The light area is broadened, and the brightness is increased.

Although the prior art lamp can increase brightness, but the prior art can t overcome the problem of having a plurality of shadows when using the prior art lamp. The LED manufacturing processes include dispensing, sealing, and mold pressing. The LED black marks are the result during the above processes. The black marks would lead to the plurality shadows and thereby influence the lighting effect of the LED.

Therefore, in view of this, the inventor proposes the present invention to overcome the above problems based on his expert experience and deliberate research.

### SUMMARY OF THE INVENTION

The object of the present invention is to provide a lamp that can overcome the plurality of shadows generated by the black marks of the LED light, wherein the black marks is naturally formed during an LED s manufacturing process that includes dispensing, sealing, and mold pressing. The present invention also can broaden the lighting area and increase the brightness and intensity of an LED.

For achieving the object described above, the present invention provides a lamp, which includes a lampshade, a seat, a light-guiding element, a reflecting layer, and a plurality of circuit boards. The seat which is installed in the lampshade is of a cylindrical shape. The light-guiding element is for light mixing. The light-guiding element is installed between the lampshade and the seat. The reflecting layer is disposed between the lampshade and the light-guiding element. Each of the circuit boards has an LED. The circuit boards are installed on the seat.

The present invention has advantageous effects as follows. The light-guiding element for light mixing (a.k.a. overlapping of light) is installed between the lampshade and the seat. Thus, the plurality of shadows generated by the LED will be eliminated and the light is brighter and the intensity of light increases. The reflecting layer is disposed between the lampshade and the seat. Thus, the light area will be broadened via the reflecting layer. And then the light is mixed via the light-guiding element. The light generated by the LED will transform from point to plane.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is an assembled perspective view showing the lamp of the present invention;

FIG. 2 is an exploded perspective view showing the lamp of the present invention;

FIG. 3 is a sectional view showing the lamp of the present invention;

FIG. 4 is a sectional view showing the lampshade of the present invention;

FIG. 5 is an exploded perspective view showing another embodiment of the present invention.

### DETAILED DESCRIPTION OF THE PREFERRED EMBODIMENTS

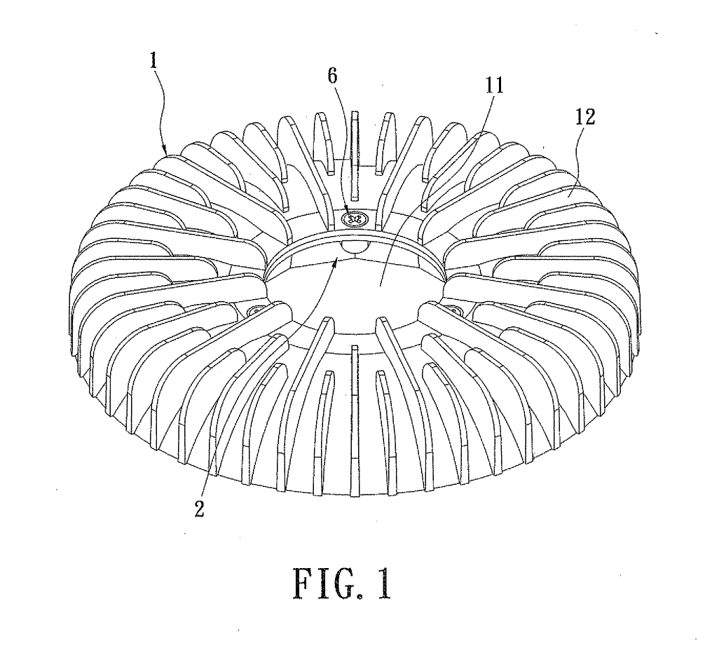

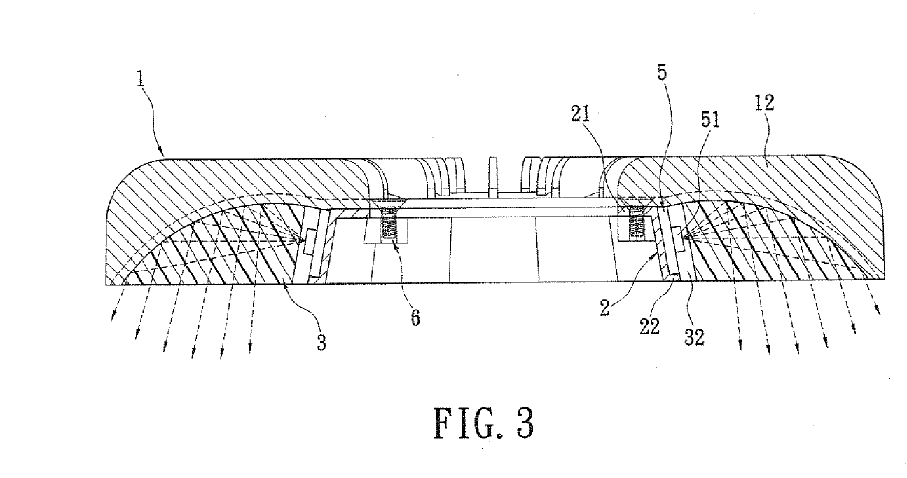

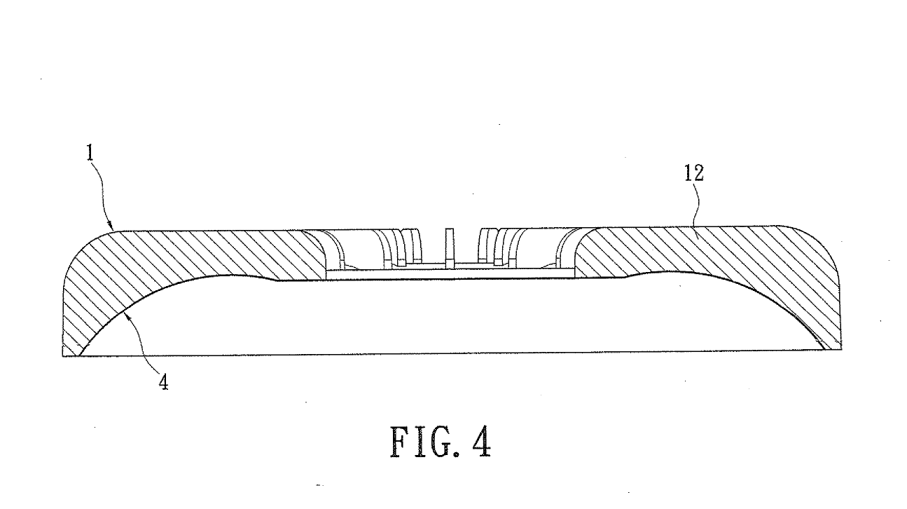

Please refer to FIGS. 1 to 4. The present invention discloses a lamp which includes a lampshade 1, a seat 2, a light-guiding element 3, a reflecting layer 4, and a plurality of circuit boards 5. In this embodiment, the lampshade 1 is made of aluminum, but the lampshade 1 can be made of other metals of good heat dissipating ability. The lampshade 1 is shaped like a bowl. The center of the lampshade 1 has a first opening 11 penetrating the lampshade 1 from top to bottom. A plurality of heat dissipating pieces 12 of different size is set around the outside of the lampshade 1. The plurality of heat dissipating pieces 12 extends from the first opening 11 to the edge of the lampshade 1.

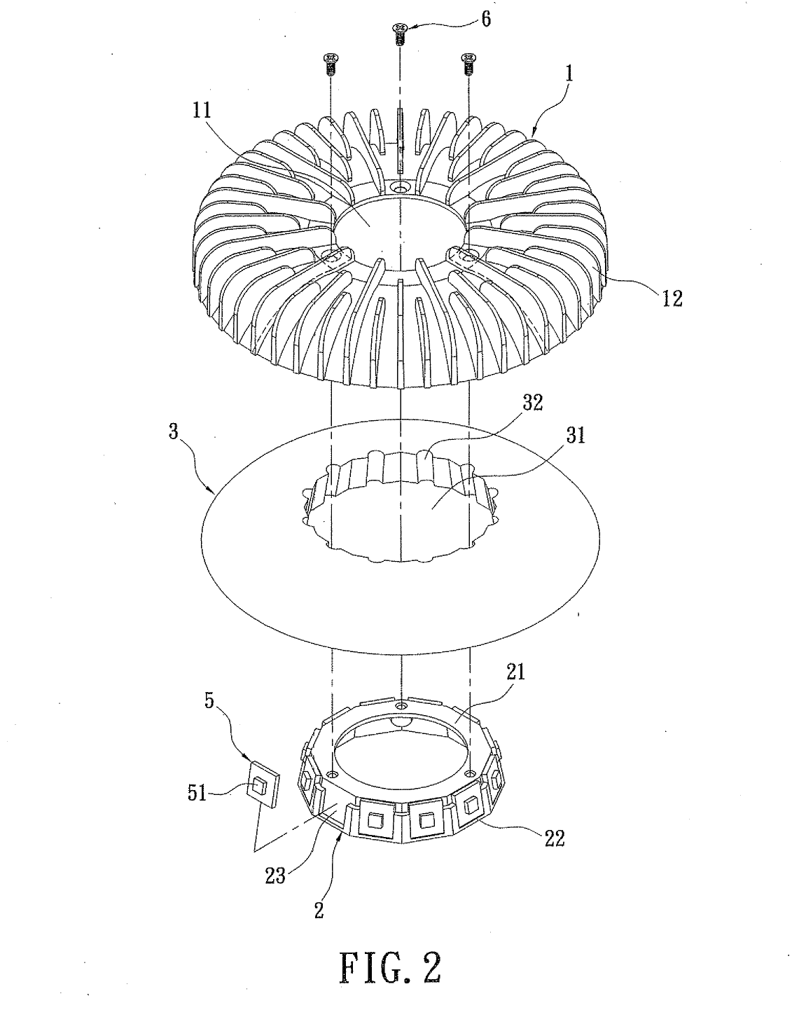

In this embodiment, the seat 2 is made of aluminum, but it can be made of other metals of good heat dissipating ability. The seat 2 with a cylindrical shape is a polygon with multilateral side surfaces (see FIG. 2). A connecting part 21 is extended inwardly from the top edge of the seat 2. The connecting part 21 is fixed in the lampshade 1 and close to the first opening 11. A clamping part 22 is extended outwardly from the bottom edge of the seat 2. A plurality of concaves 23 is set equidistantly around the outside of the seat 2.

The light-guiding element 3 for light mixing is made of transparent material, like acrylic or polycarbonate (PC). The light-guiding element 3 is shaped like a bowl. The center of the light-guiding element 3 has a second opening 31 corresponding to the first opening 11. The inside edge of the light-guiding element 3 corresponding to the outside edge of the seat 2 is multilateral. A plurality of channels 32 are formed at the inside edge of the seat 2 and penetrating the seat 2 from top to bottom. The light-guiding element 3 is installed between the lampshade 1 and the seat 2.

The reflecting layer 4 is a metal film of aluminum, silver, chromium, or alloy of the above metal combination. In this embodiment, the metal film is evenly adhered to the inside surface of the lampshade 1 by evaporation, spraying paint, or sputtering. The metal film also can be adhered to the outside surface of the light-guiding element 3 by evaporation, spraying paint, or sputtering.

The circuit boards 5 are of square shape. An LED 51 is set on the center of each of the circuit boards 5. The plurality of circuit boards 5 are installed on the plurality of concaves 23 of the seat 2 respectively. The LEDs 51 corresponds to the channels 32 respectively. When the connecting part 21 is fixed in the lampshade 1 via a plurality of screws 6, the clamping part 22 and the lampshade 1 would clamp the circuit boards 5 because of the fixing force of the screws 6. Thus, the circuit boards 5 is fixed between the seat 2 and the light-guiding element 3.

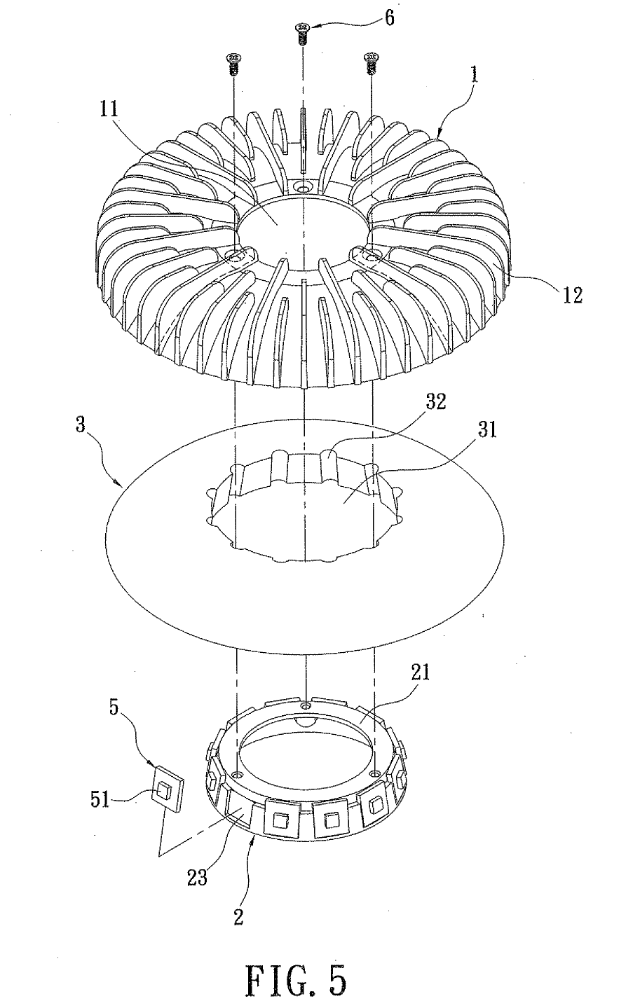

Please referring FIG. 5, FIG. 5 is an exploded perspective view showing another embodiment of the present invention. The difference between the embodiment and the above embodiment are that the seat 2 with cylindrical shape is circular with one side surface, while seat 2 in the first embodiment is a polygon with multilateral side surfaces. The inside edge of the light-guiding element 3 corresponding to the outside edge of the seat 2 is like a cylinder too.

The light-guiding element 3 for light mixing is installed between the lampshade 1 and the seat 2. Thus, the plurality of shadows generated by the LED 51 will be eliminated and the light is brighter and with increased intensity. The reflecting layer 4 is evenly adhered between the lampshade 1 and the seat 2. Thus, the light area will be broadened via the reflecting layer 4. And then the light is overlapped (i.e. light mixing) in the light-guiding element 3. The light generated by the LED will transform from point to plane.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lamp, including:
a lampshade;
a seat with a cylindrical shape being installed in the lampshade;
a light-guiding element which is for light mixing being installed between the lampshade and the seat;
a reflecting layer being disposed between the lampshade and the light-guiding element; and
a plurality of circuit boards being installed on the seat, each of the circuit boards having an LED.

2. The lamp according to claim 1, wherein the lampshade is made of aluminum, and a plurality of heat dissipating pieces are set around the outside of the lampshade.

3. The lamp according to claim 1, wherein the center of the lampshade has a first opening penetrating the lampshade from top to bottom.

4. The lamp according to claim 3, wherein the light-guiding element is made of transparent material.

5. The lamp according to claim 1, wherein the seat with a cylindrical shape is a polygon with multilateral side surface.

6. The lamp according to claim 1, wherein a connecting part is extended inwardly from the top edge of the seat, the connecting part is fixed in the lampshade via a plurality of screws, and a clamping part is extended outwardly from the bottom edge of the seat, the clamping part clamps the plurality of circuit boards, and a plurality of concaves are set equidistantly around the outside of the seat, the plurality of circuit boards is respectively installed in the plurality of concaves of the seat.

7. The lamp according to claim 1, wherein a plurality of channels are formed at the inside edge of the seat.

8. The lamp according to claim 1, wherein the reflecting layer is a metal film, the metal film is adhered to the inside surface of the lampshade by evaporation, spraying paint, or sputtering.

9. The lamp according to claim 1, wherein the reflecting layer is a metal film, the metal film is adhered to the outside surface of the light-guiding element by evaporation, spraying paint, or sputtering.

10. The lamp according to claim 1, wherein the seat with a cylindrical shape is circular with one side surface.
